(19) United States
(12) Patent Application Publication
(10) Pub. No.: US 2026/0274037 A1
(43) Pub. Date: Sep. 17, 2026

(54) METHOD OF THERMALLY CONDITIONING A CHILD SAFETY SEAT INSTALLED IN A VEHICLE

(71) Applicant: Gentherm Incorporated, Novi, MI (US)

(72) Inventors: Vikrant Varandani, Novi, MI (US); Ajay Murgod, Novi, MI (US); Ayush Garg, Milford, MI (US); Devang Marvania, Commerce Twp., MI (US); Satya Mandali, Wixom, MI (US)

(21) Appl. No.: 19/562,233

(22) Filed: Mar. 10, 2026

Related U.S. Application Data
(60) Provisional application No. 63/769,831, filed on Mar. 11, 2025.

(51) Int. Cl. B60H 1/00; B60N 2/26

(52) U.S. Cl. CPC B60H 1/00742; B60H 1/00878; B60N 2/268

(57) ABSTRACT

A method is provided for delivering thermal comfort to a child seated in a child safety seat installed in a rear seat of a vehicle. The method includes determining whether a child safety seat is present or installed in the rear seat. A vehicle controller and/or vehicle climate control system activates or adjusts one or more vehicle thermal effectors positioned adjacent to the rear seat of the vehicle, to thermally condition a region of the vehicle in which the child safety seat is located.

### CROSS-REFERENCE TO RELATED APPLICATIONS

This application claims priority to US 63/769,831 filed on March 11, 2025, the entirety of which is hereby incorporated by reference herein for all purposes.

### FIELD

These teachings relate to a method and system for thermally conditioning a child safety seat installed in a vehicle.

### BACKGROUND

Some vehicles include one or more devices for improving occupant comfort. For example, some vehicle seats include one or more thermal devices to provide heating and/or cooling functions to an occupant of the vehicle seat. However, such devices typically provide little thermal effects to a child in a child safety seat. Accordingly, it may be desirable to improve the current state in the art to utilize or operate currently available thermal devices if/when a child safety seat is detected in the vehicle to improve comfort of the child in the child safety seat.

### SUMMARY

A method for providing thermal comfort to a child in a child safety seat located in a rear seat of a vehicle is disclosed, the method includes determining or detecting presence of the child safety seat in the rear seat of the vehicle; and after the presence of the child safety seat is determined or detected in the rear seat of the vehicle, then changing an operational state of one or more vehicle thermal conditioners at a region of the child safety seat.

A method for providing thermal comfort to a child in a child safety seat in a vehicle is disclosed, the method includes steps of determining or detecting presence of the child safety seat in the vehicle; after the presence of the child safety seat is determined or detected in the vehicle seat, then determining if the child safety seat is front facing or rear facing relative to a direction of travel of the vehicle. If the child’s safety seat is determined or detected to be rear facing, then activating a rear facing child safety seat thermal conditioning mode. If the child safety seat is determined or detected to be front facing, then activating a front facing child safety seat thermal conditioning mode.

In one aspect, a vehicle includes a controller and one or more vehicle thermal effectors configured to provide localized thermal conditioning to a child safety seat installed in a rear seat of the vehicle. The system is configured to determine presence or installation of the child safety seat in the rear seat and to determine an orientation of the child safety seat relative to a direction of vehicle travel. Based on the determined orientation, the controller selectively activates or adjusts one or more thermal effectors to provide orientation-dependent thermal conditioning to the child safety seat and/or a region proximate the child safety seat.

In certain embodiments, if the child safety seat is determined to be rear-facing, the controller activates or adjusts a rear-facing child safety seat thermal conditioning mode. The rear-facing mode may include activation of a neck thermal conditioner, a seat back thermal conditioner, and a headliner thermal conditioner. In other embodiments, if the child safety seat is determined to be front-facing, the controller activates or adjusts a front-facing child safety seat thermal conditioning mode, which may include activation of a rear panel thermal conditioner and a headliner thermal conditioner. In some implementations, activation of one set of thermal effectors may be accompanied by deactivation of one or more other thermal effectors to tailor thermal delivery based on orientation.

In further aspects, the system may automatically reposition one or more components of the rear seat and/or a front seat to influence the magnitude, direction, or distribution of thermal energy directed toward the child safety seat. Such repositioning may include adjusting an inclination of a seat back relative to a seat bottom, vertically adjusting a seat bottom toward or away from a headliner thermal conditioner, or translating one or more seats relative to one another. These adjustments may be performed using electrically powered actuators controlled by the vehicle controller to enhance thermal delivery to the child safety seat.

In certain embodiments, at least one activated or adjusted thermal effector may operate in a pull mode to draw cabin air from a region proximate the child safety seat through a heat exchange device to remove thermal energy from the region. In other embodiments, the system may monitor temperature within the region proximate the child safety seat using one or more temperature sensors positioned within the rear seat, headliner, or vehicle interior. The controller may adjust output of the activated or adjusted thermal effectors to maintain the region within a stored predetermined temperature range, including limiting operation to prevent overheating or overcooling.

In some implementations, detection of the child safety seat and determination of orientation may be carried out using one or more detection devices, including a vehicle camera, a LATCH system sensor, a weight sensor, tether anchor detection, or image data analysis. The controller may use this information to automatically select and implement the appropriate thermal conditioning mode. In other configurations, the controller may propose a recommendation to a driver of another occupant of the vehicle to make the appropriate thermal effector and/or seat position adjustments.

### BRIEF DESCRIPTION OF THE DRAWINGS

FIG. 1 is a side view of a vehicle comprising vehicle seats.

FIG. 2A is a perspective view of a rear vehicle seat.

FIG. 2B is a perspective view of a top portion of a rear vehicle seat.

FIG. 3 is a perspective view of a rear portions of the front vehicle seats.

FIG. 4 is a flow diagram illustrating the method disclosed herein.

FIG. 5 is a side view of a rear facing child safety seat in a rear vehicle seat.

FIG. 6 is a side view of a rear facing child safety seat in a rear vehicle seat.

FIG. 7 is a side view of a rear facing child safety seat in a rear vehicle seat.

FIG. 8 is a side view of a front facing child safety seat in a rear vehicle seat.

### DETAILED DESCRIPTION

FIG. 1 illustrates a vehicle 10. The vehicle 10 comprises a vehicle controller and/or a vehicle climate control system 11. The vehicle 10 comprises an interior or cabin 13 comprising one or more front vehicle seats 12 and one or more rear vehicle seats 14. The one or more rear vehicle seats 14 may be positioned behind or rearward of the one or more front vehicle seats 12 in vehicle position. The one or more rear vehicle seats 14 may be second row seats that are behind first row seat, third row seats that are behind second row seats, etc. Similarly, the one or more front seats 12 may be seats that are in front of or forward of the rear seats 14 in vehicle position. The one or more front seats 12 may be first row seats, second row seats, etc.

The vehicle 10 and/or the one or more vehicle seats 12, 14 comprise one or more thermal effectors. A thermal effector may be one or more devices that are configured to provide thermal effects to an occupant(s) of the vehicle. For example, a thermal effector may be a device configured to provide heating, cooling, ventilation, humidity, and other thermal effects to an occupant(s).

In some embodiments, the one or more thermal effectors disclosed herein may be electrically powered by a vehicle power source, such as a vehicle battery and/or an electrical energy storage system associated with the vehicle 10. The thermal effectors may be electrically coupled to the vehicle controller and/or vehicle climate control system 11 via a vehicle communication network, such as a controller area network (CAN) bus, LIN bus, Ethernet-based vehicle network, or equivalent communication architecture. The vehicle controller may generate control signals that regulate power delivery to the thermal effectors in accordance with the methods described herein. In certain embodiments, operation of one or more thermal effectors may be permitted only when the vehicle ignition is in an ON state. In other embodiments, one or more thermal effectors may be activated during a remote start condition or pre-conditioning mode prior to vehicle ignition, including during cabin pre-heating or pre-cooling events.

The interior or cabin 13 of the vehicle 10 comprises one or more roof or headliner panels 16 arranged above the vehicle seats 12, 14. The one or more headliner panels 16 comprise one or more roof or headliner panel thermal effectors 18. A roof or headliner panel thermal effectors 18 may be located or arranged in a vicinity of, above, and/or facing one or more of the vehicle seats 12, 14.

The vehicle 10 or interior or cabin 13 of the vehicle may comprise one or more interior panels 20. An interior panel 20 may be a side panel, door panel, a pillar (e.g, A pillar, B pillar, C pillar, etc.), a console, a floor mat, a foot well, or a combination thereof. The one or more interior panels 20 comprise one or more interior panel thermal effectors 22 located or arranged in a vicinity of, adjacent to, and/or facing one or more of the vehicle seats 12, 14.

While the vehicle 10 is illustrated in FIG. 1 as an automobile having two rows of seats, the vehicle 10 may be a muti-row vehicle such as a bus, train, airplane, boat, or the like.

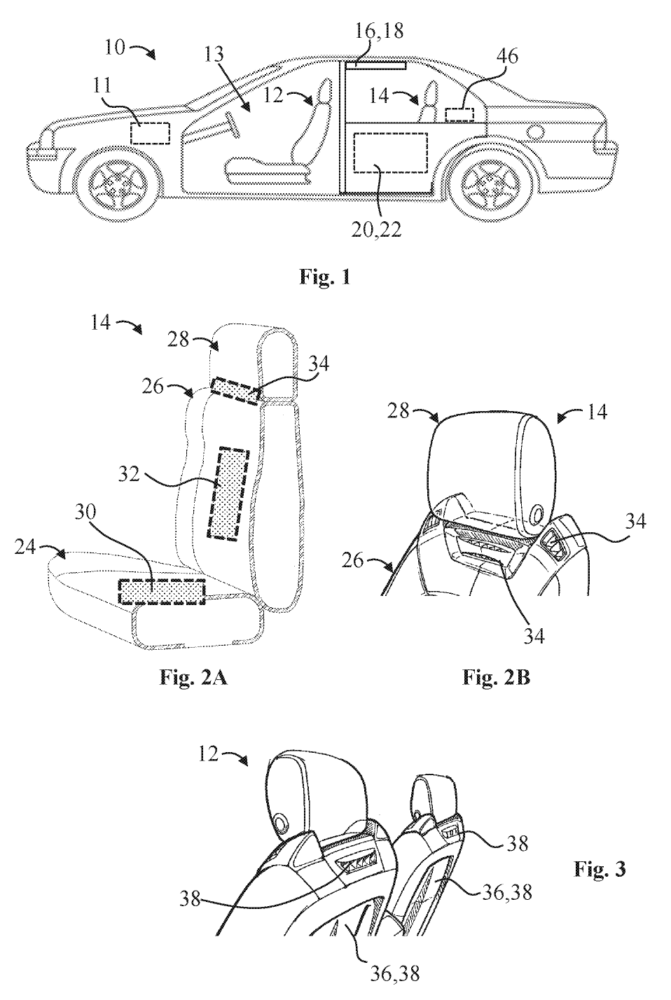

Referring now to FIGS. 2A and 2B, the one or more rear seats 14 may comprise a seat cushion or bottom 24, a seat back 26, and a headrest 28. The seat cushion or bottom 24 may comprise one or more seat cushion thermal conditioners 30, the seat back 26 may comprise one or more seat back thermal conditioners 32, and/or the headrest 28 (and/or seat back 26 and/or a region between the headrest 28 and seat back 26 and/or shoulder regions of the vehicle seat 14) may comprise one or more thermal conditioners 34, hereafter referred to as neck and/or shoulder thermal conditioners 34.

Referring now to FIG. 3, one or more of the front seats 12 comprise a rear seatback panel 36 on a rear portion of the front seat 12 that faces the rear seats 14. The seatback panel 36 or rear portion of the front seat 12 comprises one or more rear panel thermal effectors 38.

One or more of the thermal effectors disclosed herein may also be referred to as a thermal conditioner, vehicle thermal effector, a vehicle seat thermal effector, a vehicle seat thermal conditioner, a vehicle thermal conditioner, a heating device, a cooling device, an air vent, an air supply, a humidity supply, or a combination thereof, unless otherwise noted. The one or more thermal effectors disclosed herein may function to change or even maintain a thermal environment or thermal climate or thermal microclimate in a region of the thermal effector and/or inside the vehicle interior or cabin 13 (FIG. 1). For example, the one or more thermal effectors disclosed herein may function to increase or raise or maintain a temperature in a region of the thermal effector and/or inside the vehicle interior or cabin 13. For example, the one or more thermal effectors disclosed herein may function to decrease or lower or maintain a temperature in a region of the thermal effector and/or inside the vehicle interior or cabin 13. For example, the one or more thermal effectors disclosed herein may function to move air or provide an air exchange region of the thermal effector and/or inside the vehicle interior or cabin 13.

The one or more thermal effectors or conditioners disclosed herein may include or may comprise a conductive, radiative, and/or convective heating device and/or a conductive, radiative, and/or convective cooling device. For example, the one or more thermal effectors or conditioners disclosed herein may be one or more seat heaters, seat coolers, ventilation devices, or any combination thereof. For example, the one or more thermal conditioners may include one or more heating mats having conductive wires or conductive inks configured to generate heat when supplied with power, one or more ventilation device configured to blow or distribute the generated heat, or any combination thereof. For example, the one or more or thermal conditions disclosed herein may be of the type disclosed in any of the following U.S. Pat. Nos. 11,033,058; 7,560,670; 7,285,748; 7,223,948; 6,838,647; 6,869,140; 6,710,303; 6,150,642; 5,451,747; 4,931,627; 4,777,351; U.S. Patent Publication Nos. 20200406797, 20200025424 2010/0289303, and/or 20070176471 all of which are expressly incorporated herein by reference for all purposes. For example, the one or more or thermal conditions disclosed herein may be a cooling mat that may include one or more cooling elements. The one or more cooling elements may be one or more graphite/graphene strips, as disclosed in U.S. Pat. No. 11,033,058 and US Publication US20200025424A1, both of which are incorporated by reference for all purposes. The one or more thermal effectors may be one or more HVAC outlets that are configured to below air (ambient, warm, and/or cold air). The one or more thermal effectors may be one or more resistive seat heaters. The one or more thermal effectors may be one or more radiative panels or devices that are incorporated into a headliner (e.g., headliner thermal conditioner), a B-pillar, a C-pillar, a D-pillar, a door panel (e.g., door panel thermal conditioner), a console, a back panel of a seat (e.g., the seat in front of the rear seat or child seat; rear seat panel thermal conditioner), a floor liner, a floor mat, or a combination thereof. A thermal effector may be an air mover (e.g., a fan). A thermal effector may be an air mover that may function to move or circulate air in a region of the child safety seat to prevent stagnate air from surrounding the car seat and/or to move or spread scents towards or away from the car seat. A thermal effector may be configured to maintain or change a microclimate in a region of the vehicle where the child safety seat is located. This means the surrounding temperature or atmosphere may be maintained, increased, or decreased. For example, in summer months, the one or more thermal effectors may function to cool the microclimate region surrounding the child seat to prevent a child from overheating. For example, in winter months, the one or more thermal effectors may function to heat or increase the microclimate region surrounding the child seat to prevent a child from being cold or freezing. For example, in spring and/or fall months, the one or more thermal effectors may function to maintain the microclimate region surrounding the child seat to prevent a child from being too cold or too warm.

In response to the determining, the method comprises activating or adjusting, by a vehicle controller and/or vehicle climate control system, one or more vehicle thermal effectors positioned adjacent to the rear seat of the vehicle, to thermally condition the child safety seat and/or a region of the vehicle in which the child safety seat is located.

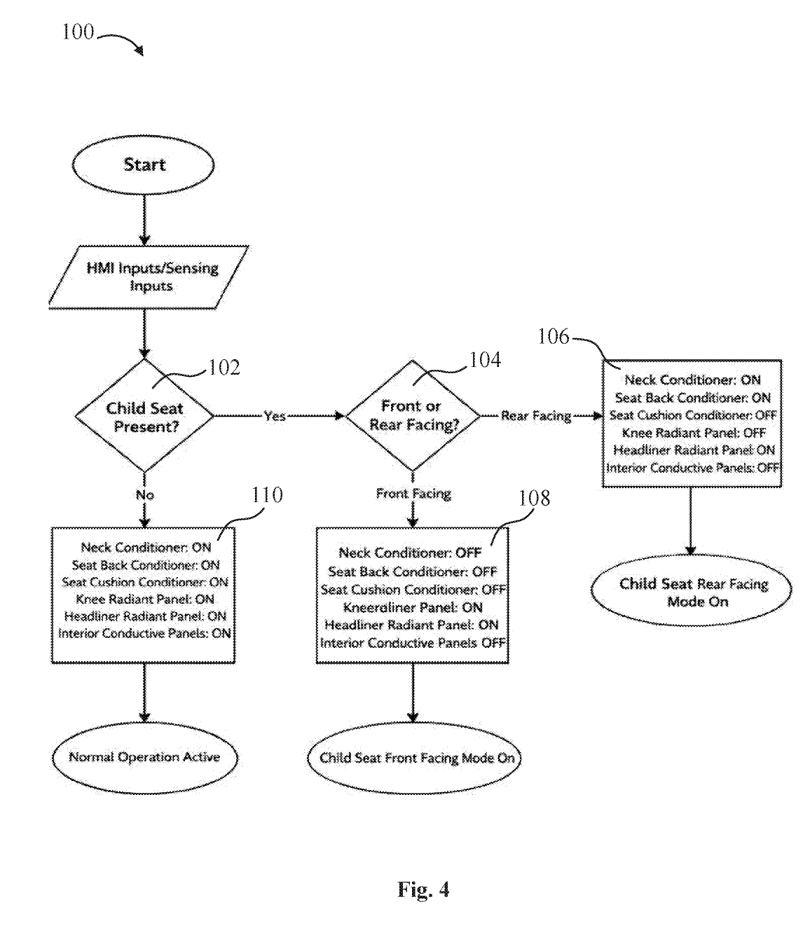

FIG. 4 illustrates a method 100 for providing or increasing thermal comfort of or to a child in a child safety seat that is present or installed in a rear seat 14 of a vehicle 10. The method 100 may be implemented by the vehicle controller and/or the vehicle climate control system 11 of the vehicle 10 (e.g., FIG. 1).

The method 100 comprises a step 102 of determining or detecting presence or installation of a child safety seat in a rear seat 14 of the vehicle 10.

This determining or detecting step 102 may be carried out using one or more detecting devices 46. The one or more detecting devices 46 may be one or more devices that are in electrical communication with the vehicle controller and/or the vehicle climate control system 11 (FIG. 1). The one or more detection devices 46 may be, for example, one or more vehicle cameras, sensors (e.g., proximity sensors, latch sensors, buckle sensors, one or more sensors on the vehicle LATCH system (e.g., Lower Anchors and Tethers For Children), weight sensors, occupancy sensors, etc.) that are configured, enabled, or programmed to detect or determine presence or absence of a child safety seat in one or more or the rear seats 14.

For example, the vehicle and/or the one or more detection devices 46 may be configured to check the rear seats 14 for presence or installation (or absence) of a child safety seat before, during, or after a vehicle is started or initially turned ON. This step 102 may also or instead include or rely on a user to inform the vehicle and/or the vehicle controller and/or the vehicle climate control system 11 of the vehicle 10 that a child safety seat is present or installed in the rear seat 14, for example by inputting information into the infotainment system or on the vehicle instrument panel of the vehicle. In some instances, the vehicle and/or the one or more detection devices 46 may be configured to periodically check the rear seats 14 for presence or installation (or absence) of a child safety seat during vehicle operation (e.g., after the vehicle has been turned ON).

If a child’s safety seat is determined or detected to be present or installed in the rear seat 14 of the vehicle 10 in step 102, the method comprises a step of changing, adjusting, modifying, activating, and/or deactivating an operational state of one or more vehicle thermal conditioners at a region of the child safety seat. This step may occur before, during, or after one or more of the steps disclosed herein. This step may be combined with one or more other steps disclosed herein. This step may include increasing an output temperature of one or more thermal effectors, decreasing an output temperature of one or more thermal effectors, moving or adjusting a position of one or more vehicle devices like one or more seats, cushions, head rests, increasing or decreasing a fan speed of a ventilator or air mover, increasing or decreasing a humidity output of one or more thermal devices, or any combination thereof. This step may be, or may include, operating one or more of the thermal effectors or conditioners in a rear facing child safety seat thermal conditioning mode, a front facing child safety seat thermal conditioning mode, or a blend or hybrid mode combining one or more effects of a front facing child safety seat thermal conditioning mode and a rear facing child safety seat thermal conditioning mode. The result of this is that a specific microclimate can be provided in a region of the child and child safety seat to improve comfort of the child that may otherwise not be available if the thermal effectors were not specifically activated or directed towards the child or the child seat.

If a child’s safety seat is determined or detected to be present or installed in the rear seat 14 of the vehicle 10 in step 102, the method may comprise a step 104 of determining if the child safety seat is front facing or rear facing, relative to a direction of travel of the vehicle 10.

“Front-facing” refers to a configuration in which the child is oriented substantially toward the forward direction of vehicle travel, such that the child’s eyes, face, and chest is directed toward the front of the vehicle and the child’s back is directed toward the rear of the vehicle. “Rear-facing” refers to a configuration in which the child is oriented substantially toward the rearward direction, opposite the forward direction of vehicle travel, such that the child’s eyes, face, and chest is directed toward the rear of the vehicle and the child’s back is directed toward the front of the vehicle.

The determination or detection if the child safety seat is front facing or rear facing in step 104 may carried out using one or more detecting devices 46. The one or more detecting devices 46 may be one or more devices that are in electrical communication with the vehicle controller and/or the vehicle climate control system 11 (FIG. 1). The one or more detection devices 46 may be, for example, one or more vehicle cameras, sensors (e.g., proximity sensors, latch sensors, buckle sensors, one or more sensors on the vehicle LATCH system (e.g., Lower Anchors and Tethers For Children), weight sensors, occupancy sensors, etc.) that are configured, enabled, or programmed to detect or determine if the child safety seat is arranged or installed to be front facing or rear facing relative to a direction of travel of the vehicle.

In some embodiments, determination of whether the child safety seat 40 is front-facing or rear-facing may be based on one or more orientation-detection mechanisms. For example, a vehicle camera may capture an image of the child safety seat 40 and an image-processing module may determine orientation based on seat geometry, harness position, or belt routing. In other embodiments, orientation may be inferred based on engagement of specific LATCH anchors, tether anchor usage, buckle sensor data, seat belt routing paths, or a combination thereof. In further embodiments, one or more position sensors, angle sensors, accelerometers, or inertial measurement units (IMUs) associated with the vehicle seat 14 or child safety seat 40 may detect an installed orientation relative to the longitudinal axis of the vehicle. Orientation determination may also include user input confirming installation direction.

If the child safety seat is determined or detected to be rear facing in step 104, then the method comprises a step 106 of activating a rear-facing child safety seat thermal conditioning mode. The rear -facing child safety seat thermal conditioning mode may comprise selectively activating, deactivating, modulating, or otherwise controlling one or more available thermal effectors based on the detected rear -facing configuration.

A “rear-facing child safety seat thermal conditioning mode” may refer to an operational mode or condition in which one or more vehicle thermal effectors are activated, adjusted, or controlled to increase, decrease, or maintain the thermal comfort of a child seated in a rear-facing child safety seat. The one or more vehicle thermal effectors may include, for example, heating elements, ventilation devices, air-moving devices, climate-control outlets, seat-integrated thermal devices, or combinations thereof that are configured to direct conditioned air or provide thermal energy to a region of the vehicle proximate the rear-facing child safety seat. For example, referring back to FIGS. 1-3 and also to FIGS. 5-8), the one or more available thermal effectors may include: a neck thermal effector 34, a seat back thermal effector 32, a seat cushion thermal effector 30, a rear panel thermal effector 38, a headliner thermal effector 18, and/or an interior panel thermal effector 22.

For example, rear-facing child safety seat thermal conditioning mode may comprise activating or turning ON or increasing the neck thermal conditioner 34, the seat back thermal conditioner 32, and the headliner thermal conditioner 18, and not activating or turning OFF or reducing the seat cushion thermal conditioner 30, the rear panel thermal conditioner 38, and the interior panel thermal conditioner 22.

The rear-facing child safety seat thermal conditioning mode may include moving or adjusting a position of the seat back 26 and/or the head rest 28 of the vehicle seat 14, and/or adjusting a position of the vehicle seat 14 relative to a front vehicle seat 12 and/or a headliner 16 of the vehicle 10.

In one example, the rear-facing child safety seat thermal conditioning mode may include repositioning one or more components of the vehicle seat 14 to influence a magnitude, direction, or distribution of thermal energy directed toward the child safety seat.

For instance, an inclination of the seat back 26 may be adjusted relative to the seat bottom 24. The seat back 26 may be moved forward in a vehicle-forward direction (and/or an angle between the seat back 26 and the seat bottom 24 may be reduced) to position the seat back 26 closer to a thermal source and thereby increase thermal conditioning toward the child safety seat. Alternatively, the seat back 26 may be moved rearward in a vehicle-rearward direction (and/or the angle between the seat back 26 and the seat bottom 24 may be increased) to reduce thermal conditioning toward the child safety seat.

In another example, the headrest 28 may be angled, tilted, translated, or otherwise repositioned toward the child safety seat to increase exposure of the child to conditioned air or radiant heat. Conversely, the headrest 28 may be angled, tilted, translated, or otherwise repositioned away from the child safety seat to reduce thermal exposure.

In further examples, the seat bottom 24 may be vertically adjusted. The seat bottom 24 may be moved upward toward the headliner 16 and/or a headliner panel thermal conditioner 18 to increase thermal effects on the child safety seat, or moved downward away from the headliner 16 and/or the headliner panel thermal conditioner 18 to decrease such thermal effects.

Additionally, the vehicle seat 14 may be translated forward in the vehicle toward the front seat 12 to increase thermal conditioning from one or more rear panel thermal conditioners 38, or translated rearward away from the front seat 12 to decrease thermal conditioning from the rear panel thermal conditioners 38.

Any adjustment of the vehicle seat 14 and/or one or more components thereof, including, without limitation, adjustment of an inclination of the seat back 26 relative to the seat bottom 24, vertical movement of the seat bottom 24, adjustment of the headrest 28, translation of the entire rear seat 14 forward or rearward, or adjustment of a front seat 12 relative to the rear seat 14, may be accomplished using one or more electrically powered and/or mechanically driven actuators. For example, the vehicle seat 12, 14 may include one or more electric motors, linear actuators, rotary actuators, gear trains, worm gears, lead screw mechanisms, rack-and-pinion assemblies, cam mechanisms, linkages, scissor-lift mechanisms, track-and-rail systems, or combinations thereof configured to move one or more seat components relative to the vehicle structure. The one or more actuators may be electrically coupled to and controlled by the vehicle controller and/or vehicle climate control system 11 via a vehicle communication network. In certain embodiments, existing power seat adjustment mechanisms may be utilized to perform the described adjustments. In other embodiments, dedicated actuators may be provided for repositioning one or more seats or seat components to optimize a magnitude, direction, or distribution of thermal energy toward a region proximate the child safety seat 40. Movement may occur incrementally, continuously, or in predefined positions, and may be limited within stored angular, positional, or travel ranges to maintain occupant safety, regulatory compliance, and structural integrity.

If the child safety seat is determined or detected to be in a front-facing orientation, the method may include a step 108 of activating a front-facing child safety seat thermal conditioning mode. The front-facing child safety seat thermal conditioning mode may comprise selectively activating, deactivating, modulating, or otherwise controlling one or more available thermal effectors based on the detected front-facing configuration.

Referring to FIGS. 1–3 and 5–8, the available thermal effectors may include a neck thermal conditioner 34, a seat back thermal conditioner 32, a seat cushion thermal conditioner 30, a rear panel thermal conditioner 38, a headliner thermal conditioner 18, and/or an interior panel thermal conditioner 22.

In one example, the front-facing child safety seat thermal conditioning mode may include activating the rear panel thermal conditioner 38 and the headliner thermal conditioner 18, and deactivating or reducing output from the neck thermal conditioner 34, the seat back thermal conditioner 32, the seat cushion thermal conditioner 30, and/or the interior panel thermal conditioner 22. In other embodiments, any combination of the available thermal effectors may be activated or deactivated to direct thermal energy toward, or limit thermal energy from, selected regions proximate the front-facing child safety seat.

The front-facing child safety seat thermal conditioning mode may further include repositioning one or more components of the vehicle seat 14 to influence a magnitude, direction, or distribution of thermal energy directed toward the child safety seat. For example, an inclination of the seat back 26 relative to the seat bottom 24 may be adjusted. The seat back 26 may be moved forward in a vehicle-forward direction (and/or an angle between the seat back 26 and the seat bottom 24 may be reduced) to increase thermal exposure, or moved rearward in a vehicle-rearward direction (and/or the angle between the seat back 26 and the seat bottom 24 may be increased) to decrease thermal exposure.

Additionally, the headrest 28 may be angled, tilted, translated, or otherwise repositioned toward the child safety seat to increase thermal effects on the child, or repositioned away from the child safety seat to decrease thermal effects. The seat bottom 24 may be vertically adjusted, such as being moved upward toward the headliner 16 and/or the headliner thermal conditioner 18 to increase thermal effects, or moved downward away from the headliner 16 and/or the headliner thermal conditioner 18 to reduce thermal effects.

The vehicle seat 14 may also be translated relative to the front seat 12. For example, the vehicle seat 14 may be moved forward in the vehicle toward the front seat 12 to increase thermal conditioning from the rear panel thermal conditioner 38, or moved rearward away from the front seat 12 to decrease thermal conditioning from the rear panel thermal conditioner 38.

The front-facing child safety seat thermal conditioning mode may differ from the rear-facing child safety seat thermal conditioning mode in terms of which thermal effectors are activated and/or how the vehicle seat components are repositioned. In some configurations, however, the front-facing and rear-facing child safety seat thermal conditioning modes may share one or more common control strategies.

If, during step 102, it is determined or detected that a child safety seat is not present or installed in the rear seat 14 of the vehicle 10, the method 100 may include a step 110 of operating one or more of the thermal effectors in a normal operating mode.

In the normal operating mode, the available thermal effectors may be controlled according to standard vehicle climate-control logic to provide thermal comfort to one or more occupants of the vehicle. For example, one or more of the available thermal conditioners may be selectively activated, deactivated, or modulated based on user inputs, sensed cabin temperature, ambient conditions, occupancy detection, or other control parameters, without regard to a child safety seat–specific thermal conditioning mode.

The method 100 may further include monitoring and/or determining a temperature within the vehicle 10 in a region proximate the child safety seat during operation of one of the thermal conditioning modes. The temperature may be measured using one or more of the detection devices and/or temperature sensors, infrared sensors, thermal imaging cameras, or other sensing devices positioned in the vehicle cabin, in the rear seat 14, at or within the child safety seat, or in one or more vehicle components such as the headliner, pillars, seat structures, or combinations thereof.

In some embodiments, the temperature in the region of the child safety seat may be estimated using one or more inputs, including outside ambient temperature, cabin air temperature, solar load, duration of operation of one or more thermal effectors, identification of which thermal effectors are active or inactive, airflow rate, humidity level, or combinations thereof.

In further embodiments, one or more sensors may be incorporated into an item associated with the child, such as clothing (e.g., a hat, socks, gloves, coat), a wearable device, or a blanket, to provide temperature-related data indicative of a thermal condition of the child.

In certain embodiments, the vehicle controller and/or vehicle climate control system 11 may include one or more safety constraints to prevent overheating or overcooling of the child safety seat region. For example, one or more maximum and/or minimum allowable temperature thresholds may be stored in memory, and output of the thermal effectors may be limited so that surface temperatures and/or air temperatures in the region of the child safety seat 40 remain within a predetermined safe range. If one or more sensors detect a temperature exceeding a threshold value, the system may automatically reduce thermal output, deactivate one or more thermal effectors, issue a warning to a vehicle occupant, and/or revert to a normal operating mode. In some embodiments, redundant sensing and/or fault detection logic may be implemented such that detection of inconsistent sensor readings results in automatic limitation or shutdown of the child safety seat thermal conditioning mode.

The method 100 may include adjusting the front-facing child safety seat thermal conditioning mode and/or the rear-facing child safety seat thermal conditioning mode based on the monitored and/or determined temperature in the region of the child safety seat. For example, the method may include increasing or decreasing a temperature setpoint, adjusting airflow rate or fan speed, modifying humidity level, selectively activating or deactivating one or more thermal effectors, or otherwise modulating thermal output to maintain or achieve a target thermal condition in the region of the child safety seat.

In some embodiments, the vehicle controller and/or vehicle climate control system 11 may implement a closed-loop control strategy for regulating the thermal conditioning modes described herein. For example, one or more sensed or estimated temperature values associated with a region of the child safety seat 40 may be compared to one or more stored target temperature values or target temperature ranges. If a deviation from the target value or range is detected, the vehicle controller may automatically increase, decrease, or otherwise modulate output of one or more thermal effectors in a proportional, stepwise, or algorithmic manner to reduce the deviation. In certain embodiments, the control strategy may include proportional control, integral control, derivative control (e.g., PID control), hysteresis-based control to reduce oscillation, lookup tables, rule-based logic, or combinations thereof. In some configurations, the system may operate in an open-loop mode when direct sensor feedback is unavailable and may transition to a closed-loop mode when sensor feedback becomes available.

The vehicle controller executes instructions stored in non-transitory memory to generate control signals that physically alter operation of one or more thermal effectors, thereby changing a temperature or airflow condition within the vehicle

FIGS. 5, 6, 7, and 8 each illustrate a child safety seat 40 in a rear seat 14 of a vehicle. In FIGS. 5, 6, and 7, the child safety seat 40 is rear-facing in vehicle position. In FIG. 8, the child safety seat 40 is front-facing in vehicle position.

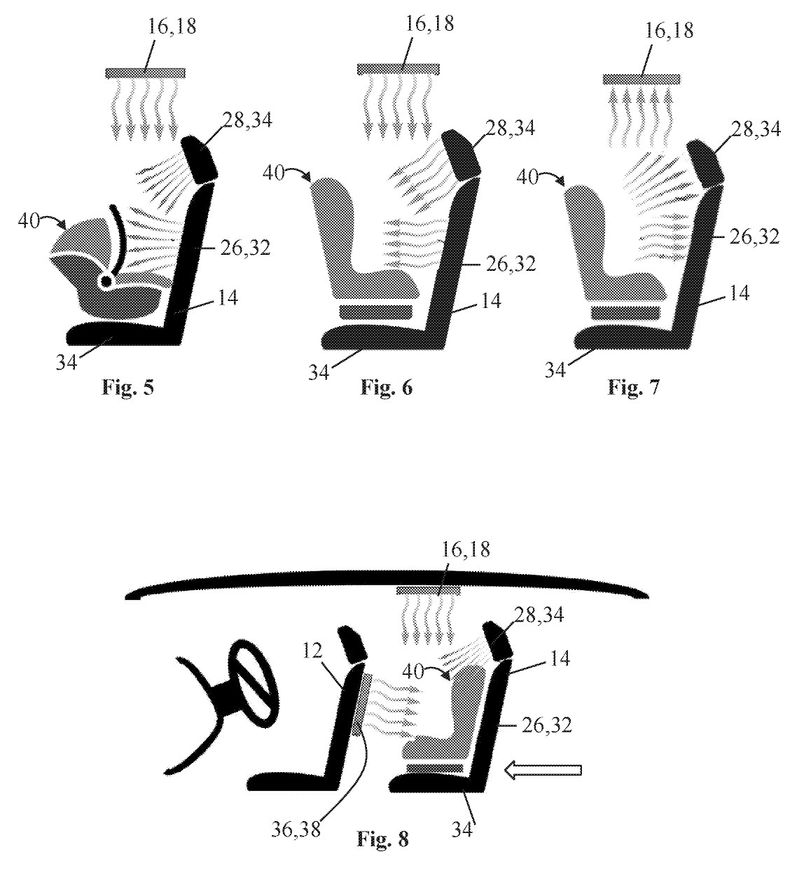

The child safety seat 40 may comprise any suitable child restraint system configured for installation in the vehicle 10. For example, the child safety seat 40 may be a cradle-type seat (e.g., an infant carrier or rear-facing infant seat configured to support an infant in a generally reclined position), such as illustrated in FIG. 5, or a booster-type seat configured to elevate a child and properly position the child relative to a vehicle seat belt system, such as illustrated in FIGS. 6–8. The systems and methods described herein may be implemented with either type of child safety seat 40, as well as with other child restraint configurations, including convertible seats and combination seats, without limitation. While not illustrated, the cradle type of child safety seat 40 may be front-facing.

With reference to FIGS. 5–7, after the presence or installation of the child safety seat 40 is determined or detected in the rear seat 14 of the vehicle 10 in step 102, and the child safety seat 40 is determined or detected to be in a rear-facing orientation in step 104, the method may include activating one or more available thermal effectors associated with the rear-facing child safety seat thermal conditioning mode.

In one example, this may include activating the neck thermal conditioner 34, the seat back thermal conditioner 32, and the headliner thermal conditioner 18. Activation of these thermal effectors may direct conditioned air and/or thermal energy toward a region proximate the rear-facing child safety seat 40 so as to thermally condition the child safety seat 40 and/or an occupant therein, including warming or cooling as desired.

To enhance efficiency of thermal conditioning directed toward the child safety seat 40, one or more components of the vehicle seat may be repositioned to influence a magnitude, direction, or concentration of thermal energy. For example, an inclination of the seat back 26 relative to the seat bottom 24 may be adjusted. The seat back 26 may be moved forward in a vehicle-forward direction (and/or the angle between the seat back 26 and the seat bottom 24 may be reduced) to increase thermal conditioning from the seat back thermal conditioner 32 toward the child safety seat 40. Conversely, the seat back 26 may be moved rearward in a vehicle-rearward direction (and/or the angle between the seat back 26 and the seat bottom 24 may be increased) to reduce thermal conditioning from the seat back thermal conditioner 32.

Similarly, the headrest 28 may be angled, tilted, translated, or otherwise repositioned toward the child safety seat 40 to increase thermal effects on the child, or repositioned away from the child safety seat 40 to decrease thermal effects.

Additionally, the seat bottom 24 and/or the entire vehicle seat assembly may be vertically adjusted. For example, the seat bottom 24 or vehicle seat may be moved upward toward the headliner 16 and/or the headliner panel thermal conditioner 18 to increase thermal effects on the child safety seat 40, or moved downward away from the headliner 16 and/or the headliner panel thermal conditioner 18 to reduce thermal effects on the child safety seat 40.

As illustrated in FIG. 7, one or more of the thermal conditioners 32, 34, and/or 18 may be configured to operate in a “pull mode.” In the pull mode, a thermal conditioner such as a blower, fan, or pump may draw air from a region proximate the child and/or the child safety seat 40 and remove heat or cooled air therefrom, thereby extracting thermal energy from the region to increase thermal comfort. In some embodiments, the pull mode may include drawing cabin air through a heat exchange device, ventilation channel, or duct to reduce localized temperature around the child safety seat 40.

Referring now to FIG. 8, after the presence or installation of the child safety seat 40 is determined or detected in the rear seat 14 of the vehicle 10 in step 102, and the child safety seat 40 is determined or detected to be in a front-facing orientation in step 104, the method may include activating one or more available thermal effectors associated with the front-facing child safety seat thermal conditioning mode.

In one example, the front-facing child safety seat thermal conditioning mode may include activating the rear panel thermal conditioner 38 and the headliner panel thermal conditioner 18 to direct conditioned air and/or thermal energy toward a region proximate the front-facing child safety seat 40 and an occupant therein.

To provide the most efficient thermal conditioning to the child safety seat 40, the inclination of the seat back 26 may be moved forward in vehicle position (and/or the angle between the seat back 26 and the seat bottom 24 may be reduced) in order to provide more or additional thermal conditioning from the rear panel thermal conditioner 38 on the back of the front seat 12. Alternatively, the inclination of the seat back 26 may be moved rearward in vehicle position (and/or the angle between the seat back 26 and the seat bottom 24 may be increased) in order to provide less thermal conditioning from the rear panel thermal conditioner 38. Similarly, the head rest 28 may be angled, tilted, or moved towards the child safety seat to increase thermal effects on the child in the child safety seat or may be angled, tilted, or moved away from the child safety seat to decrease thermal effects on the child in the child safety seat. Moreover, the seat cushion 24 or the entire seat 14 may be moved upwardly towards the headliner 16 and/or headliner panel thermal conditioner 18 to increase thermal effects on the child safety seat, or may be moved downwardly away from the headliner 16 and/or headliner panel thermal conditioner 18 to reduce thermal effects on the child safety.

Many advantages can be gleaned from these teachings. For example, the teachings herein ensures the most vulnerable passengers are shielded from the extremes of temperature, reducing the risk of overheating or hypothermia. By maintaining a stable and comfortable microclimate, it directly contributes to the safety and well-being of infants and children. The system's smart controls can adapt to various conditions and preferences, allowing for customization of the child’s microclimate based on individual needs. Automatic activation and adjustment save time and effort for caregivers, with intuitive controls making operation straightforward. With integrated sensors and smart controls, the system and method can automatically adjust heating levels based on the cabin temperature and specific needs, enhancing user convenience. By focusing heat directly where it is needed, the system and method may use less energy compared to heating the entire cabin or using an inefficient seat heater not designed for baby seats.

In certain embodiments, the system may operate in an “advisory mode” or “recommendation mode” rather than automatically activating or modifying the thermal effectors and/or seat positions. In such advisory or recommendation modes, upon determining presence and/or orientation of the child safety seat, the vehicle controller may generate and present a recommendation to activate a rear-facing child safety seat thermal conditioning mode or a front-facing child safety seat thermal conditioning mode. The system may additionally recommend activation, deactivation, or modulation of one or more specific thermal effectors and/or repositioning of one or more seat components. The recommendation may be displayed via an infotainment interface, instrument cluster, mobile application, or other user interface, and may be accepted, rejected, or adjusted by a vehicle occupant. In some implementations, the vehicle controller may include adaptive logic, machine learning, and/or deep learning algorithms configured to analyze historical user adjustments to prior recommendations. Based on stored user preference data and prior override behavior, the system may refine future recommendations to better align with user preferences and usage patterns. In such embodiments, thermal conditioning actions may be executed only after user confirmation, while the system continues to learn and update recommendation parameters for subsequent vehicle operations.

A “microclimate” refers to a localized thermal zone within a predetermined distance (e.g., within 30 cm–1 meter) of the child safety seat.

The method disclosed herein also includes using one or more sensors (temperature, humidity, facial, etc.) to prevent overheating of a child in a card safety seat, and the smart controls ensure energy efficiency by activating one or more thermal effectors only when necessary. These components constantly monitor the temperature and humidity within the child's immediate surroundings and adjust the system's output accordingly. The sensors also allow the system to communicate with the vehicle’s central HVAC system, making it possible to maintain a specific target temperature for the child seat zone without affecting the rest of the cabin. Moreover, by positioning the child safety seat within or around the headrest of the rear seats, the neck conditioner unit has the capability to channel hot or ambient air towards the child. It can quickly adjust its output to provide immediate comfort changes, maintaining a stable temperature around the child's head and upper body. The radiant heating element may be integrated beneath the upholstery of the vehicle's second-row or rear seats. Utilizing infrared technology, it emits heat upwards to create a warm zone directly around the child safety seat without direct contact. This element operates on the principle of radiant heat transfer, which is ideal for creating a uniform and safe warming effect suitable for the sensitive nature of infants.

It is understood that the following method steps can be performed in virtually any order and are not necessary to be in the order disclosed herein unless otherwise noted. One or more of the steps can be combined with one or more other steps; one or more steps can be omitted or eliminated; one or more steps can be repeated or duplicated; one or more steps can be split into two or more steps; one or more of the steps can be rearranged in a different order relative to other method steps; or any combination hereof.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of "a" or "one" to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers, and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers, and/or sections disclosed herein are not necessarily limited to a single embodiment. Instead, any of the elements, components, regions, layers, and/or sections disclosed herein may be substituted, combined, and/or modified with any of the elements, components, regions, layers, and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1. A method for providing thermal comfort to a child in a child safety seat installed in a rear seat of a vehicle, the method comprising:
determining presence or installation of the child safety seat in the rear seat of the vehicle;
in response to the determining, the method comprises activating or adjusting, by a vehicle controller and/or vehicle climate control system, one or more vehicle thermal effectors positioned adjacent to the rear seat of the vehicle, to thermally condition the child safety seat and/or a region of the vehicle in which the child safety seat is located.

2. The method of claim 1, wherein the one or more vehicle thermal effectors comprise: a neck thermal conditioner, a seat heater, and/or an air mover.

3. The method of claim 1, wherein the one or more vehicle thermal effectors comprise a rear seat panel thermal conditioner, a headliner thermal conditioner, and/or a door panel thermal conditioner.

4. The method of claim 1, wherein the method comprises determining an orientation of the child safety seat relative to a direction of vehicle travel.

5. The method of claim 4, wherein if the orientation of the child safety seat is determined to be rear-facing, then the activating comprises operating a rear-facing child safety seat thermal conditioning mode, and if the orientation of the child safety seat is determined to be front-facing, then the activating comprises operating a front-facing child safety seat thermal conditioning mode.

6. The method of claim 5, wherein the rear-facing child safety seat thermal conditioning mode comprises activating a neck thermal conditioner, a seat back thermal conditioner, and a headliner thermal conditioner, and/or the front-facing child safety seat thermal conditioning mode comprises activating a rear panel thermal conditioner and a headliner thermal conditioner.

7. The method of claim 1, wherein the determining presence or installation of the child safety seat comprises receiving input from one or more detection devices comprising a camera, a LATCH system sensor, or a weight sensor.

8. The method of claim 1, wherein the determining the orientation of the child safety seat comprises detecting at least one of LATCH anchor engagement, tether anchor usage, or image data from a vehicle camera.

9. The method of claim 1, further comprising automatically repositioning at least one component of the rear seat to influence distribution of thermal energy toward the child safety seat.

10. The method of claim 9, wherein repositioning comprises adjusting an inclination of a seat back relative to a seat bottom using an electrically powered actuator, and/or vertically adjusting a seat bottom toward or away from a headliner thermal conditioner using an electrically powered actuator.

11. The method of claim 1, wherein at least one of the activated thermal effectors operates in a pull mode to draw cabin air from the region proximate the child safety seat through a heat exchange device.

12. The method of claim 1, further comprising monitoring temperature in a region proximate the child safety seat using at least one temperature sensor positioned within the rear seat or a headliner.

13. The method of claim 12, further comprising adjusting output of the activated thermal effectors to maintain the region proximate the child safety seat within a stored predetermined temperature range.

14. The method of claim 2, wherein the activating is performed in an advisory mode in which a recommendation is generated to activate a rear-facing child safety seat thermal conditioning mode or a front-facing child safety seat thermal conditioning mode based on the determined orientation of the child safety seat, and wherein activation of the recommended child safety seat thermal conditioning mode occurs only after user confirmation by a user or operator of the vehicle.

15. The method of claim 14, wherein generating the recommendation comprises applying adaptive logic including a machine learning or deep learning algorithm configured to analyze prior user adjustments to the recommendation and to modify future recommendations of the child safety seat thermal conditioning mode and/or seat repositioning based on stored user preference data.

16. The method of claim 1, wherein the activating is performed in an advisory mode in which a recommendation is generated to activate a thermal conditioning mode, and wherein activation of the recommended child safety seat thermal conditioning mode occurs only after user confirmation by a user or operator of the vehicle.

17. A method for thermally conditioning a child safety seat installed in a rear seat of a vehicle, the method comprising:
determining presence of the child safety seat in the rear seat;
determining whether the child safety seat is rear-facing or front-facing relative to a direction of vehicle travel;
wherein if the child safety seat is determined to be rear-facing, then activating or adjusting, a neck thermal conditioner, a seat back thermal conditioner, and a headliner thermal conditioner; and adjusting an inclination of a seat back relative to a seat bottom to influence thermal energy directed toward a region proximate the child safety seat;
wherein if the child safety seat is determined to be front-facing, then activating a rear panel thermal conditioner and a headliner thermal conditioner.

18. The method of claim 17, wherein if the child safety seat is determined to be rear-facing, the method further comprises vertically adjusting a seat bottom toward a headliner thermal conditioner to increase thermal effects on the child safety seat.

19. The method of claim 16, further comprising monitoring a temperature in a region proximate the child safety seat and limiting operation of at least one of the activated thermal conditioners to maintain the region within a predetermined safe temperature range.

20. A method for thermally conditioning a child safety seat installed in a rear seat of a vehicle, the method comprising:
determining presence of the child safety seat in the rear seat;
determining whether the child safety seat is rear-facing or front-facing relative to a direction of vehicle travel;
if the child safety seat is determined to be rear-facing, activating, by a vehicle controller and/or vehicle climate control system, then activating or adjusting a rear-facing child safety seat thermal conditioning mode;
if the child safety seat is determined to be front-facing, then activating or adjusting, by the vehicle controller and/or the vehicle climate control system, a front-facing child safety seat thermal conditioning mode; and
repositioning at least one component of the rear sea and a front seat of the vehicle to influence a magnitude, direction, or distribution of thermal energy directed toward a region proximate the child safety seat.
